(19) United States
(12) Patent Application Publication
(10) Pub. No.: US 2007/0195359 A1
(43) Pub. Date: Aug. 23, 2007

(54) Image forming apparatus, image processing method and storage medium storing program for image processing

(75) Inventors: Hiroyoshi Uejo, Kanagawa (JP); Kenji Koizumi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/516,557

(22) Filed: Sep. 7, 2006

(30) Foreign Application Priority Data
Feb. 17, 2006 (JP) 2006-041052

(51) Int. Cl. G06F 3/12

(52) U.S. Cl. 358/1.15

(57) ABSTRACT

An image forming apparatus that forms an image based on image data input thereto, includes a mode switching unit that switches between a save mode in which an amount of consumption of imaging material is reduced and a normal operation mode in which an amount of consumption of imaging material is not changed, a gain processing unit that decreases a gain of a specific frequency component, based on a spatial frequency characteristic of an input image, during operation under the save mode, and an output unit that outputs the input image under the normal operation mode or an image processed by the gain processing unit under the save mode according to the selection made by the mode switching unit.

### BACKGROUND

1. Technical Field

The present invention relates to image forming apparatuses such as printers, copiers, and the like as well as an image processing method and a storage medium that stores a program for image processing. More particularly, the present invention relates to a technique for reducing the amount of consumption of imaging material (or coloring material) such as toner and ink.

2. Related Art

At the present time, there are various methods of image formation such as electrophotographic and ink jet for image forming equipment such as printers and copiers. Whatever method is applied, it is common to form an image by fixating imaging material (or coloring material) such as toner and ink on a medium such as paper. Therefore, to curb the running cost of the equipment, it is effective to reduce the amount of consumption of the imaging material and something needs to be devised for this purpose. In this relation, diverse approaches exist.

### SUMMARY

According to an aspect of the present invention, an image forming apparatus that forms an image based on image data input thereto, includes a mode switching unit that switches between a save mode in which an amount of consumption of imaging material is reduced and a normal operation mode in which an amount of consumption of imaging material is not changed, a gain processing unit that decreases a gain of a specific frequency component, based on a spatial frequency characteristic of an input image, during operation under the save mode, and an output unit that outputs the input image under the normal operation mode or an image processed by the gain processing unit under the save mode according to the selection made by the mode switching unit.

### BRIEF DESCRIPTION OF THE DRAWINGS

Exemplary embodiments of the present invention will be described in detail based on the following figures, wherein:

FIG. 1 illustrates an image forming apparatus which is an exemplary embodiment of the present invention;

FIG. 2 shows a functional structure of a controller in this exemplary embodiment;

FIG. 3 shows an example of a spatial frequency characteristic graph of an image;

FIGS. 4A and 4B illustrate examples of sets of coefficients for a 3×3 digital filter; and

FIG. 5 is a flowchart illustrating a flow of image output operation of the image forming apparatus to which this exemplary embodiment is applied.

### DETAILED DESCRIPTION

Exemplary embodiments of the present invention will now be described in detail with reference to the accompanying drawings.

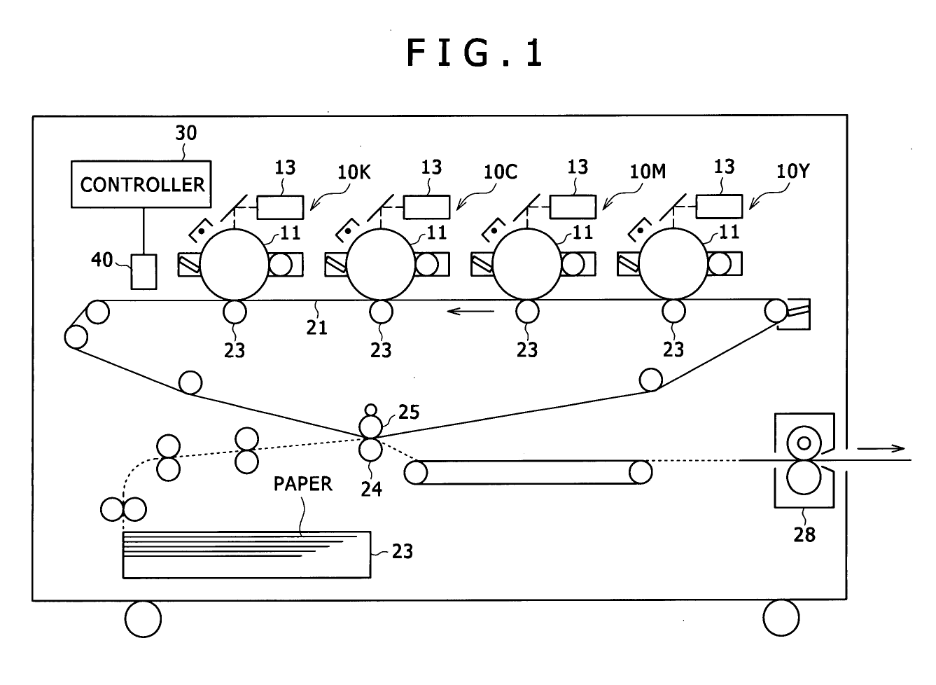

FIG. 1 illustrates an image forming apparatus which is an exemplary embodiment of the present invention.

This image forming apparatus is a so-called tandem type digital color electrophotographic printer. As shown in FIG. 1, this image forming apparatus includes image forming units 10 which form images, exposure units 13 as a printing function, which form electrostatic latent images on photoconductor drums 11 in the image forming units 10, and a transfer belt 21 as an intermediate transfer member, which carries a multi-color image into which toner images, each carried by and transferred from the photoconductor drums 11, are merged. The four image forming units 10 are provided respectively for yellow (Y), magenta (M), cyan (C), and black (K) colors. In the following description, where their distinction is needed, the image forming units are denoted as 10Y, 10M, 10C, 10K; otherwise, they are simply denoted as image forming units 10. Inside the transfer belt 21, first transfer rollers 23 are provided in position to face and contact the photoconductor drums 11 of each image forming unit 10 in order to transfer toner images onto the transfer belt 21. In a so-called second transfer position where a multi-color toner image carried by the transfer belt 21 is transferred onto paper, a second transfer roller 24 and its mating roller 25 which is provided inside the transfer belt 21 are placed. Moreover, the apparatus includes a paper cassette 27 which houses sheets of paper which is a recording medium and a fixing device 28 for heat fixing a multi-color toner image onto paper. Furthermore, the image forming apparatus includes a controller 30 for processing an image to be printed for various purposes and color misregistration sensors 40 which read a pattern for color registration control formed in a certain region on the transfer belt 21.

The controller 30 generates image signals such as digital image signals of an image obtained from an image data input part such as an image input terminal (IIT) and a pattern image for color misregistration control and supplies the image signals to the exposure units 13 so that the corresponding image will be transcribed onto the transfer belt 21. The controller 30 obtains the results of detection of a pattern for color misregistration control from the color misregistration sensors 40, analyzes the amount of color misregistration, based on the obtained information, and makes corrections required. In this exemplary embodiment, furthermore, the controller performs image control for restraining the amount of toner consumption, as necessary. These functions of the controller 30 are realized by, for example, a program-controlled CPU (Central Processing Unit) or the like. The controller 30 is equipped with a nonvolatile ROM (Read Only Memory) and a readable/writable RAM (Random Access Memory) as memories. In the ROM, software programs for control of operations to be performed by the controller, such as image formation, color misregistration detection, and correction, and image information representing patterns for color misregistration control are stored. In the RAM, many kinds of information which are obtained during the operation of the image forming apparatus, such as the values of counters, job execution count, information about previous detection of color misregistration (e.g., at the time of detecting misregistration) are stored.

To the exposure units 13 provided for each color, digital image signals are supplied via the controller 30; these signals are created through conversion by an image processing device (not shown) from image data obtained from, for example, the IIT, an external personal computer (PC), and the like. A color misregistration sensor 40 is a reflective sensor which makes a pattern for color misregistration control (a ladder patch of toners or chevron patch), which is formed on the transfer belt 21, focused onto a detector element made up of a PD (Photo Diode) sensor or the like and outputs a pulse when the centroidal line of the patch aligns with the center line of the detector. For example, two color misregistration sensors 40 are placed downstream of the most downstream image forming unit 10K in FIG. 1 and along the fast-scanning direction, in order to detect relative color misregistration for a pattern for color misregistration control, namely, a patch formed through the image forming units 10. As light emitting elements of the color misregistration sensors 40, two infrared LEDs (with a wavelength of 880 nm) are used and configured such that the amount of light emission of each LED can be adjusted (for example, in two steps) to ensure stable pulse output.

In each of the image forming units 10Y, 10M, 10C, 10K for the four colors, various units for image formation are provided around the photoconductor drum 11 as an image carrier in a similar fashion; that is, a charging unit which charges the photoconductor drum 11, a development unit which develops a toner image on the photoconductor drum 11 illuminated by the exposure unit 13, a clear which removes toner residues from the surface of the photoconductor drum 11 after transfer of a toner image onto the transfer belt 21, and so on. It is also possible that the arrangement of the image forming units 10 includes an additional image forming unit for a specific color adapted for a special imaging material, e.g., corporate color, which is not used for normal color image formation, along with so-called regular colors for imaging, yellow (Y), magenta (M), cyan (C), and black (K). It is also possible to use five or more colors including dark yellow in addition to the above four Y, M, C, and K colors as the colors for regular use. In this exemplary embodiment, the axial direction of the photoconductor drum 11 as the image carrier is assumed to be a fast-scanning direction and the direction in which a toner image moves along with the rotation of the photoconductor drum 11 is a slow-scanning direction.

As the transfer belt 21, an endless belt of, for example, flexible synthetic resin film such as polyamide is used, which is provided by shaping the film material into a belt and joining the ends of the belt by welding or the like. This transfer belt 21 is tightly stretched by driving rollers and backup rollers to make a loop in which at least a part of the belt is substantially straightened. Along the substantially straight section of the transfer belt 21, the image forming units 10Y, 10M, 10C, 10K for the four colors and their mating first transfer rollers 23 are arranged, spaced at given intervals in a substantially horizontal direction. In the example shown in FIG. 1, the image forming unit 10Y for yellow, the image forming unit 10M for magenta, the image forming unit 10C for cyan, and the image forming unit 10K for black are arranged in order in the direction from upstream to downstream in the direction in which the transfer belt 21 moves during a transfer operation. Toner images of each individual color formed by the image forming units 10 are merged in order on the belt, as the transfer belt 21 moves; thereby a multi-color toner image is formed on the transfer belt 21. The movement of the transfer belt 21 is timed with the transportation of paper and the multi-color toner image formed on the transfer belt 21 is transferred onto paper in the position where the second transfer roller 24 and its mating roller 25 exist. Then, the paper having the multi-color toner image transferred onto it is transported to the fixing device 28 where the image is heat fixated on the paper which is further carried and ejected out to an exit tray provided outside the chassis of the image forming apparatus.

Although an example of a configuration of an electrophotographic image forming apparatus is shown in FIG. 1, this exemplary embodiment is applicable to various types of image forming apparatus such as an ink jet type and a thermal type. While the image forming apparatus shown here is a so-called tandem type digital color printer, this exemplary embodiment is also applicable to various configurations of image forming equipment such as four-cycle type color printers and single color printers.

In this exemplary embodiment, the image forming apparatus configured as above applies image processing that is performed in such a way as to reduce the amount of consumption of toner (imaging material) without degrading the quality of an output image relative to its corresponding input image, if at all possible. The basic concept underlying the present invention is to decrease the density of an image portion where tone variation is little, for example, a portion painted with a single color. By executing this processing only for such a position with little tone variation, the image quality degradation can be restrained. A concrete method is to analyze the spatial frequency characteristic of an image and decrease the gain (Modulation Transfer Function: MTF) of a DC component of spatial frequency in the image, using a digital filter. The functions of the controller 30 for realizing this exemplary embodiment are described below.

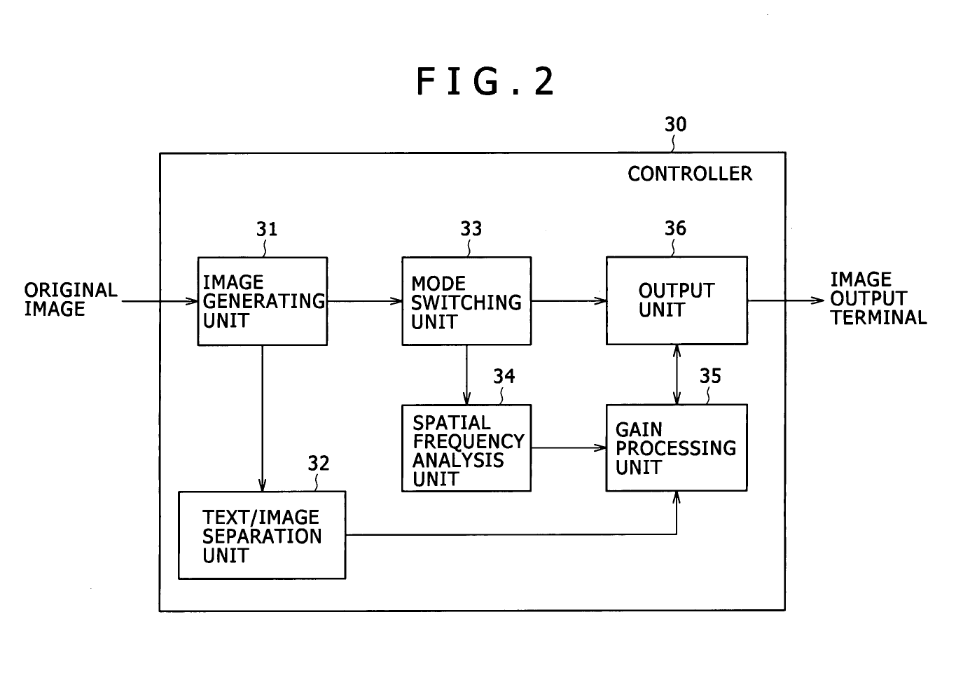

FIG. 2 shows a functional structure of the controller 30 in this exemplary embodiment.

Referring to FIG. 2, the controller 30 of the exemplary embodiment includes an image generating unit 31 which generates data representing an image to be output, a text/image separation unit 32 which makes a distinction between text and image for an object in an image generated, a mode switching unit 33 which carries out a mode switchover of the image forming apparatus, a spatial frequency analysis unit 34 which analyzes the spatial frequency characteristic of an image, a gain processing unit 35 which decreases the gain of a specific frequency component, and an output unit 36 which sends image data processed by necessary processing to the image output terminal (IOT). These functions are realized by the CPU controlled by the software programs stored in the above-mentioned nonvolatile ROM.

The image generating unit 31 receives input of the original of an image which will be output, rasterizes it, and generates image data for output. The original to be input to the image generating unit 31 may be an electronic original created using a word processor or graphic software or electronic data converted from an original scanned by an original input part such as a scanner. The image generating unit 31 is also capable of screening an image generated, which is applied in an area coverage modulation method and the like.

The text/image separation unit 32 makes a distinction between text and non-text image for each of individual objects constituting an image generated by the image generating unit 31. The function of the text/image separation unit 32 can be realized by an existing text/image separation technique.

The mode switching unit 33 accepts a selection action from the external via a certain user interface and switches the operation mode of the image forming apparatus to normal operation mode or save move in which the amount of consumption of imaging material is reduced. This mode switching unit 33 is connected to the user interface such as, for example, a console panel provided for the image forming apparatus. The mode switching unit accepts a mode selection action performed by a user through the user interface and carries out operation mode switchover. When in the normal operation mode, the mode switching unit 33 sends an image generated by the image generating unit 31 directly to the output unit 36. When in the save mode, the mode switching unit 33 sends the image to the spatial frequency analysis unit 34.

The spatial frequency analysis unit 34 analyzes the spatial frequency characteristic of an image sent from the mode switching unit 33. The spatial frequency characteristic is indicative of a tone variation of the image. The smaller this value, the tone variation is smaller (mild). Inversely, the larger this value, the tone variation is larger (sharp). The analysis of the spatial frequency characteristic of an image can be carried out by an existing analysis method.

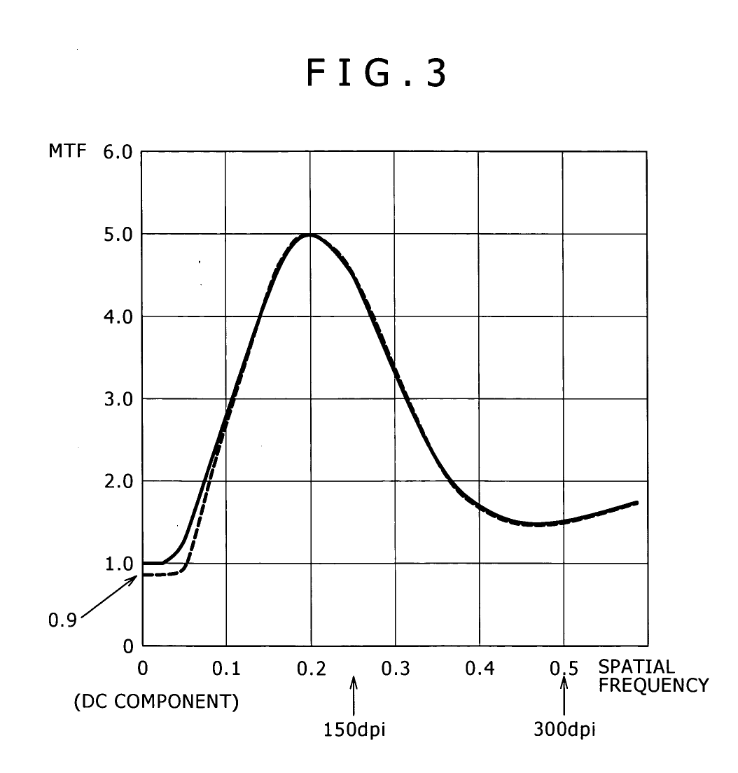

The gain processing unit 35, which is embodied in, for example, a digital filter, decreases the gain of a fixed frequency component, specifically, for example, the DC component (frequency=0), based on the spatial frequency characteristic of the image analyzed by the spatial frequency analysis unit 34. The decrease ratio of gain may be set at, for example, about 5 percent. The spatial frequency characteristic can be expressed in a graph with spatial frequencies plotted on the abscissa and MTF values plotted on the ordinate, as is shown in FIG. 3. In FIG. 3, a slid line curve indicates an example of the spatial frequency characteristic of a certain image and a dotted line curve indicates the characteristic in which the gain of the DC component has been decreased by the gain processing unit 35. Referring to FIG. 3, The DC component portion of the frequency characteristic (dotted line curve) after gain processing is lower by 5 percent as compared with the characteristic (solid line curve) before the processing. By reducing the gain of the DC component, that is, the portion where there is no tone variation (so-called solid portion), it is possible to reduce the amount of use of imaging material without exerting so much of a visual influence on the output image.

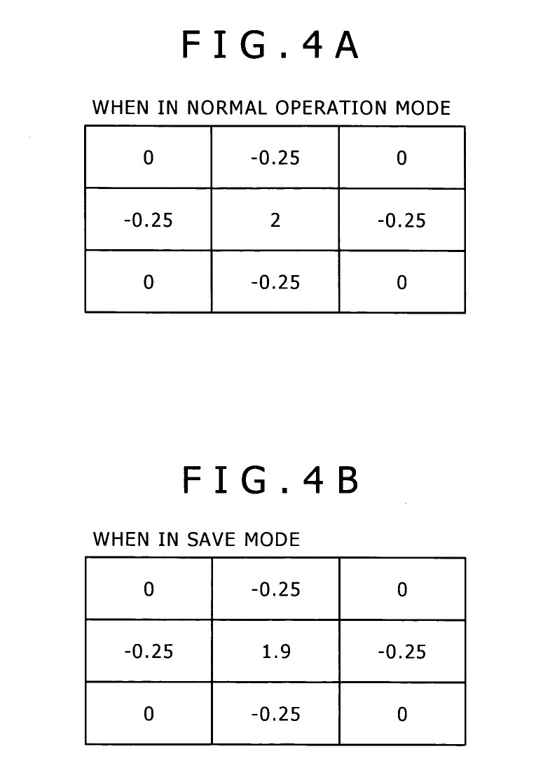

In the gain processing unit 35, the above gain processing is carried out by switching one set of to another set of coefficients (parameters) which are used in, for example, the digital filter. FIGS. 4A and 4B illustrate examples of sets of coefficients for a 3×3 digital filter. From the comparison between one set of coefficients which are used in normal operation mode shown in FIG. 4A with another set of coefficients which are used in save mode shown in FIG. 4B, a coefficient value in the center position in save mode is smaller by 0.1. By calculating a convolution integral of this set of coefficients with a density value of the image, a decrease of 5 percent in the gain with regard to the DC component of spatial frequency can be accomplished. The coefficient sets as shown are stored beforehand in the memory (such as ROM) for the controller 30 to allow the gain processing unit 35 to read and use one that is appropriate for the operation mode.

The gain processing unit 35 can execute filtering, using a set of coefficients appropriate for each of individual objects in the image, based on the result of text/image distinction made by the text/image separation unit 32. Specifically, for example, the set of coefficients for the normal operation mode, as shown in FIG. 4A, is used for a text object and the set of coefficients for save mode, as shown in FIG. 4B, is used for a non-text image object. In this way, by using the appropriate set of coefficients according to the type of the object and executing the gain processing only for an image object, the sharp contrast of text in an output image can be maintained even when the apparatus operates in the save mode.

The output unit 36 delivers an image received from the mode switching unit 33 (when in the normal operation mode) or an image received from the gain processing unit 35 (when in the save mode) to the exposure units 13 in the image output terminal (IOT).

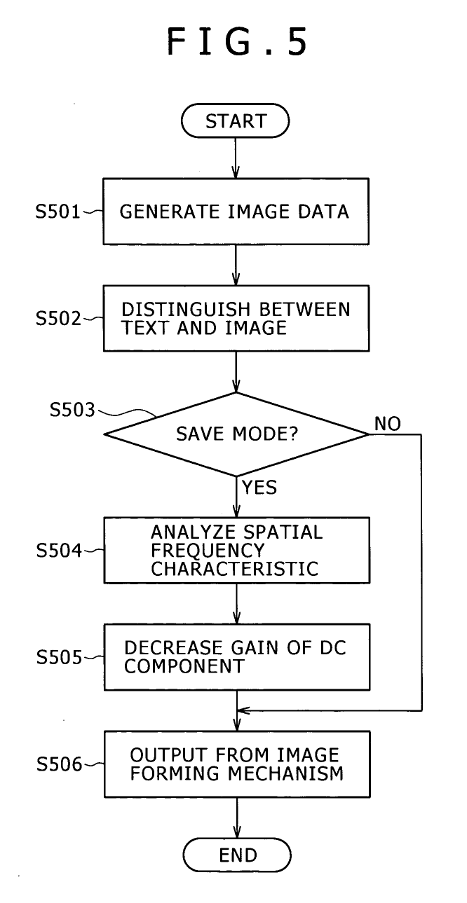

FIG. 5 is a flowchart illustrating a flow of image output operation of the image forming apparatus to which this exemplary embodiment is applied.

First, the image generating unit 31 receives input of an original (electronic original) of an image to be output from the input part such as a scanner and an external device and generates image data for output (step 501). Next, the text/image separation unit 32 makes a distinction between a text object and an image object in the generated image (step 502).

Meanwhile, the mode switching unit 33 receives a user selection action through the user interface and selects the operation mode of the image forming apparatus (step 503). If the normal operation mode has been selected (No at step 503), from the image data generated by the image generating unit 31, an image is formed and output on a recording medium such as paper by the image forming mechanism of the image forming apparatus (step 506).

Otherwise, if the save mode has been selected by the mode switching unit 33 (Yes at step 503), the spatial frequency analysis unit 34 analyzes the spatial frequency characteristic of the image generated by the image generating unit 31 (step 504). Then, the gain processing unit 35 decrease the gain of the DC component of an image recognized as an image object by the text/image separation unit 32 (step 505). From the image data in which the gain has been processed as above, an image is formed and output on a recording medium such as paper by the image forming mechanism of the image forming apparatus (step 506).

In the above example of operation, immediately after image data is generated by the image generating unit 31, the image data is processed by the text/image separation unit 32. However, the distinction between a text object and an image object in the image data may be performed at any timing, provided it is completed before the image data is processed by the gain processing unit 35. Image objects to be analyzed by the spatial frequency analysis unit 34 may be limited to image objects other than text objects before being processed by the gain processing unit 35.

While the foregoing exemplary embodiment illustrates the case where the present invention is applied to the electrophotographic image forming apparatus, the present invention is applicable to other types of image forming equipment such as an ink jet type in a similar fashion. The present invention can contribute to reducing the amount of consumption of imaging material (such as toner and ink) used in each type, while restraining image quality degradation, wherever possible, and curbing the running cost of the equipment.

The present invention may be embodied in other specific forms without departing from its spirit or characteristics. The described embodiments are to be considered in all respects only as illustrated and not restrictive. The scope of the present invention is, therefore, indicated by the appended claims rather than by the foregoing description. All changes which come within the meaning and range of equivalency of the claims are to be embraced within their scope.

What is claimed is:

1. An image forming apparatus that forms an image based on image data input thereto, comprising:
a mode switching unit that switches between a save mode in which an amount of consumption of imaging material is reduced and a normal operation mode in which an amount of consumption of imaging material is not changed;
a gain processing unit that decreases a gain of a specific frequency component, based on a spatial frequency characteristic of an input image, during operation under the save mode; and
an output unit that outputs the input image under the normal operation mode or an image processed by the gain processing unit under the save mode according to the selection made by the mode switching unit.

2. The image forming apparatus according to claim 1, wherein the gain includes a modulation transfer function.

3. The image forming apparatus according to claim 1, wherein the gain processing unit decreases a gain of a DC component of spatial frequency in the input image.

4. The image forming apparatus according to claim 1, wherein the mode switching unit accepts a mode selection made by a user and carries out operation mode switchover according to the selection.

5. The image forming apparatus according to claim 4, further comprising a user interface via which the mode selection made by the user is accepted.

6. The image forming apparatus according to claim 1, further comprising a text/image separation unit that makes a distinction between text and image for an object in the input image,
wherein the gain processing unit executes processing on the object recognized as an image.

7. An image forming apparatus that forms an image based on image data input thereto, comprising:
an analysis unit that analyzes a spatial frequency characteristic of an input image;
a gain processing unit that performs processing on a gain of a specific frequency component either to decrease the gain or to leave the gain unchanged, based on a result of analysis of the spatial frequency characteristic; and
an output unit that outputs an image based on the input image processed by the gain processing unit.

8. The image forming apparatus according to claim 7, wherein the gain includes a modulation transfer function.

9. The image forming apparatus according to claim 7, wherein the gain processing unit performs processing on a gain of a DC component of spatial frequency in the input image.

10. The image forming apparatus according to claim 7, further comprising a mode switching unit that selects whether to cause the gain processing unit to decrease the gain or to leave the gain unchanged,
wherein the output unit outputs an image based on the input image processed by the gain processing unit, according to selection made by the mode switching unit.

11. The image forming apparatus according to claim 7, further comprising a text/image separation unit that makes a distinction between text and image for an object in the input image,
wherein the gain processing unit executes processing on the object recognized as an image.

12. An image processing method comprising:
analyzing a spatial frequency characteristic of an input image;
performing processing on a gain of a specific frequency component either to decrease the gain or to leave the gain unchanged, based on a result of analysis of the spatial frequency characteristic; and
outputting an image based on the input image for which the processing on the gain has been done.

13. The image processing method according to claim 12, further comprising accepting a mode selection by a user and switching between a save mode in which an amount of consumption of imaging material is reduced and a normal operation mode in which an amount of consumption of imaging material is not changed,
wherein, only after switching to the save mode, analyzing the spatial frequency characteristic and performing the processing on the gain of a specific frequency component are executed.

14. The image processing method according to claim 12, further comprising making a distinction between text and image for an object in the input image,
wherein, for the object recognized as an image, analyzing the spatial frequency characteristic and performing the processing for the gain of a specific frequency component are executed.

15. A storage medium readable by a computer, the storage medium storing a program of instructions executable by the computer to perform a function for image processing, the function comprising:
analyzing a spatial frequency characteristic of an input image;
performing processing on a gain of a specific frequency component either to decrease the gain or to leave the gain unchanged, based on a result of analysis of the spatial frequency characteristic; and
outputting an image based on the input image for which the processing on the gain has been done.
